(19) United States
(12) Patent Application Publication
(10) Pub. No.: US 2012/0117588 A1
(43) Pub. Date: May 10, 2012

(54) METHOD AND DEVICE TO CONTROL IPTV SETTINGS FROM A SECOND DISPLAY

(75) Inventors: Charles McCoy, Coronado, CA (US); Ling Jun Wong, Escondido, CA (US); True Xiong, San Diego, CA (US)

(73) Assignees: SONY NETWORK ENTERTAINMENT INTERNATIONAL LLC, Los Angeles, CA (US); SONY CORPORATION, Tokyo (JP)

(21) Appl. No.: 12/982,338

(22) Filed: Dec. 30, 2010

Related U.S. Application Data
(60) Provisional application No. 61/412,298, filed on Nov. 10, 2010.

(51) Int. Cl. H04N 5/445; H04N 7/16; H04N 7/173

(52) U.S. Cl. 725/28; 725/38

(57) ABSTRACT

Systems and methods for allowing a user to control IPTV settings from a second display, e.g., on an external device. In one implementation, such settings include brightness, volume, parental controls, input controls, language, clock, zip code etc. On-screen preview, wherever applicable, is also available when changing settings using the second display. This allows the user to change the settings of the TV without disturbing the TV screen.

### CROSS-REFERENCE TO RELATED APPLICATIONS

This application claims benefit of priority of U.S. Provisional Patent Application No. 61/412,298, filed Nov. 10, 2010, entitled “Method and Apparatus to Control IPTV Settings from a 2^{nd} Display”, owned by the assignee of the present invention and herein incorporated by reference in its entirety. Also incorporated by reference in their entireties are co-owned U.S. patent applicant Ser. No. 12/844,205, filed Jul. 27, 2010, entitled “Control of IPTV Using Second Device”, U.S. Patent Application entitled “Second Display Support Of Character Set Unsupported On Playback Device”, filed concurrently herewith, U.S. Patent Application entitled “Device Registration Process From Second Display”, filed concurrently herewith, U.S. Patent Application entitled “Web Browser As Second Display Control Display”, filed concurrently herewith, and U.S. Patent Application entitled “Employment of Multiple Second Displays To Control IPTV Content”, filed concurrently herewith.

### BACKGROUND

Currently, when a user has to adjust the settings of a TV, e.g., brightness, parental controls, language, captioning, volume, etc., generally the current activity has to be disrupted, e.g., viewing of a content item must be temporarily suspended. This is disruptive, but also leads to the difficulty of adjusting such settings on the TV, which may be located away from the user, and is in addition difficult to use as a user interface for settings adjustments. It is also disruptive because the user interface for adjusting such settings is displayed on top of the content, rendering it difficult to see the effect of the adjustments.

Moreover, hiding the settings user interface when the user is adjusting the settings is confusing, as remote control button presses would be interpreted as control commands for a user interface the user could not see. To the user, or others, the TV does not appear to be in a mode in which the settings are being adjusted.

In addition, the typical remote control is also difficult to use as an input device to adjust such settings. Some solutions have been attempted, but the same are generally directed towards changing the ambience of the viewing area, e.g., changing an ambient lighting level, not for adjusting the settings of the television itself

### SUMMARY

Systems and methods are disclosed that allow a user to control content playback device settings from a second display, without disturbing or disrupting content playback. In one example of a method of operation, using a second display, the user switches to a “settings” menu on a user interface, and selects so as to make changes to a setting of the IPTV, e.g. brightness. The second display, e.g., employing an application thereon, sends the information to the IPTV, so that the IPTV can perform, for some settings, an instant preview of the intended setting, e.g., brightness, before actually confirming the change. During this time the content playback device, e.g., IPTV, may still be performing its current activity. The system may then ask the user to confirm the adjusted value of the setting. The user confirms and the application transmits a signal to the IPTV which then sets the brightness accordingly.

In another example, the user may set parental settings. In this case, the user may enter a pin which is sent to the IPTV for authentication. After successful authentication, the user is able to change the parental settings or to view a content item protected by a parental control. As above, the system and method allow that these settings can be adjusted while the television is still actively showing content.

In one implementation, such settings include brightness, volume, parental controls, input controls, language, clock, zip code etc. Settings from another content playback device may be inherited, e.g., settings from a prior content playback device may be employed to conveniently enter one or more setting into a new content playback device.

To control content playback device settings, a group of users may exploit individual “second displays” to control settings, view, browse, and navigate content or data service offerings, by service providers, e.g., internet network services, on behalf of a content playback device, e.g., IPTV, the same having authenticated credentials for playback of such content.

The second displays serve as a visual aid to the IPTV, but generally do not require additional investment by the user because the same make use of a device, e.g., a smartphone, laptop computer, tablet computer, a desktop, an internet appliance, etc., which most users would already have in their possession. Such a second display is a complement to an IPTV because of the second display's strength in supported languages and character font sets, data entry, processing power, and user experience in content management. The application running on the second display may be a web application (scripting or non-scripting), a native application, a Java application, or any other sort of application that may work with a content playback device. For example, the ASP/.NET framework with RPC can be employed to write the second display application. Where the web application running on the second display is written in HTML or HTML with Javascript, the same may be loaded by any device with a browser, and so the same is not limited to only a small set of compatible devices or expensive remote controls.

Communications with service providers may take place through a proxy server, and the proxy server presents to service providers the authentication credentials of the content playback device, so that the second displays appear to the service providers as an authenticated content playback device. In many cases, changing settings does not involve sensitive user information, service provider information, or content, and so an IPTV device need not be identified and authenticated first.

The second displays may include any device that can run an application that communicates with a content playback device, including, but not limited to, personal computers, laptop computers, notebook computers, netbook computers, handheld computers, personal digital assistants, mobile phones, smart phones, tablet computers, hand-held gaming devices, gaming consoles, and also on devices specifically designed for these purposes, in which case the special device would include at least a processor and sufficient resources and networking capability to run the web application.

The content playback device can take many forms, and multiple content playback devices can be coupled to and selected within a given local network. Exemplary content playback devices may include IPTVs, DTVs, digital audio systems, or more traditional video and audio systems that have been appropriately configured for connectivity. In video systems, the content playback device includes a processor controlling a video display to render content thereon.

In a general method, a user employing a second display has a user account with a source or clearinghouse of services. Here, the source or clearinghouse is represented as a user account on a management server, but it should be understood that the user account may be with a service provider directly. In any event, this account has information stored thereon related to what content playback devices are associated with the account. When a user logs on, they may see this list of content playback devices and may choose a particular content playback device. If there is only one content playback device on the network, or if the user is browsing in a way that the content playback device identity is not needed, then this step may be omitted.

Once a content playback device has been chosen, a list of services may be displayed (if more than one is available). The list of services may be customized to those that have content playable on the chosen content playback device, or all available content may be displayed, in which case, in certain implementations, a notation may be displayed adjacent the content item as to whether it is playable on the selected device. Where no content playback device has been selected, all available content may be displayed. If no content playback device has been selected, but the user account includes stored information about which content playback devices are available, then all content may be displayed, a subset of all content may be displayed based on the known content playback devices associated with the account, or notations may be presented about which content playback devices can play which content, or a combination of these. In some cases, a content service provider may require a content playback device to be chosen. In other cases, no content playback device need be chosen and the user may simply choose and queue content for later playback by a content playback device to-be-determined at a later time.

Assuming multiple services are available, the user then selects a service to browse. The service presents a list of available content items as noted above. The presentation may be in any number of forms, including by category, or in any other form of organization. The proxy server presents an authentication credential of the content playback device to the content server. In some cases, service provider credentials for accessing the various services may be stored in the account, and presented by the proxy server or management server to the content server when needed.

Individual services may employ their own DRM schemes which the current system may then incorporate. For example, if a video content service provider only allows a certain predetermined number of devices on which their content may be played back, then this rule will be enforced or duplicated within the current system and method. Moreover, changes to such service provider parameters may be periodically polled for by the proxy server and/or management server, or the same may be polled for at the next login of the service. In other words, upon login, the system and method may poll for and receive a token associated with the given service provider, the token providing information to the system about the user account with the content service provider.

The system and method may include a management server which, along with the content playback device, communicates with at least one content server such that the content server provides content items for presentation or access of the content item at the content playback device. The system and method may further include a proxy server communicating with the management server and the second displays. In some cases, the proxy server may be merged with the management server, or in other cases a separate proxy server may be provided for each content server or service provider.

In another aspect, a proxy server includes at least one processor and at least one network interface communicating with the processor to establish communication between the processor and a wide area network. At least one computer-readable storage medium is accessible to the processor and bears logic causing the processor to receive login information from a second display. Responsive to a determination that the login information is correct, the server sends to the second display a local IP address of the content playback device associated with the login information. The proxy server receives from the second display information about the content playback device requesting a list of services available to the content playback device from at least one content server of a service provider and sends a request for the list of services to a management server. The proxy server receives from the management server the list and sends it to the second display for presentation of information on a video display thereof. The proxy server receives from the second display a request for a content item and, responsive to the request of the content item, requests a service login of the content server. The proxy server receives back from the content server a list of items, assets, categories or services and sends the list to the second display. In this way, the list can be presented on a video display of the second display so that a user can navigate to enter a selection to command the content playback device to play the selection.

In another aspect, the invention is directed toward a method of controlling settings of a content playback device using a second display, including: instantiating an application on a second display, the second display coupled to a content playback device, the application configured to control at least one setting of the content playback device; on a user interface of the second display, the user interface indicating a setting of the content playback device, adjusting a value of a content playback device setting; and transmitting a signal to cause the content playback device setting to change to the adjusted value.

Implementations of the invention may include one or more of the following. The setting may correspond to an audio or video setting, and the method may further include: upon the adjusting, transmitting a signal to cause the content playback device setting to change to the adjusted value to preview an effect of the adjusting; requesting confirmation from a user for the adjusted value of the setting; and responsive to receiving confirmation from a user for the adjusted value of the setting, performing the step of transmitting a signal to cause the content playback device setting to change to the adjusted value. The setting may correspond to a parental control, and the method may further include: upon the adjusting, requesting a passcode from a user; and responsive to a correct passcode being entered by a user, allowing a modification of the parental control setting or allowing access or playback of a content item protected by the parental control. If the user has requested a content item from a service provider, the passcode request may originate from the service provider. The setting may correspond to a channel, and the method may further include: displaying a channel guide; responsive to an adjusted channel value being indicated by a user, performing the step of transmitting a signal to cause the content playback device channel setting to change to the adjusted value. The transmitting a signal may include transmitting a signal directly from the second display to the content playback device via a wireless transmission scheme selected from the group consisting of: Bluetooth®, WiFi, or infrared. The content playback device may be an IPTV or a digital video recorder. The adjusting a value of a content playback device setting may include adjusting the value to equal a stored value, the stored value associated with another content playback device.

In another aspect, the invention is directed toward a non-transitory computer-readable medium, including instructions for causing a computing device to implement the above method.

In another aspect, the invention is directed toward a second display, including: a display module, including a settings user interface module, where the settings user interface module is configured to display a grouping or categorization of settings, a number of settings within each grouping or category, the current value of one or more settings, and a way to receive an adjustment of the value of those settings; and a network communications module including a content playback device communications module for communications with a content playback device.

Implementations of the invention may include one or more of the following. The second display may be configured to communicate directly with a content playback device through the network communications module, and the direct communication may be via a wireless link. The second display may include a web-browsing module for browsing the web.

In another aspect, the invention is directed toward a second display, including: a processor; memory bearing computer readable instructions capable of instantiating an application, the application configured to control at least one setting of a content playback device; memory bearing computer readable instructions capable of receiving and indicating a value of the setting; memory bearing computer readable instructions capable of receiving an adjustment of a value of the setting; memory bearing computer readable instructions capable of transmitting a signal to cause the setting to change to the adjusted value.

Implementations of the invention may include one or more of the following. The second display may further include memory bearing computer readable instructions capable of receiving a user input of a passcode or confirmation, memory bearing computer readable instructions capable of displaying a channel guide on a user interface, memory bearing computer readable instructions capable of accessing a stored value of the setting of a content playback device, or memory bearing computer readable instructions capable of storing or caching settings adjustments. Stored values of settings may be retrieved from another content playback device, a default value, or a current value of the content playback device. Alternatively, stored values may be retrieved from information stored in the user account or a location on the local network.

Advantages of certain embodiments of the invention may include one or more of the following. Additional ways are provided to control TVs through a secondary display. The content playback device setting control may be performed conveniently on the second display, without disturbing other viewers, and because of the capabilities of the second display may be performed in a language and character font set that is preferable to a user. The system and method are not tied to any particular technology—generally, any appropriately-configured second display, that can operate an application that can interact with a content playback device, may be employed to control any appropriately-configured content playback device. Settings may be inherited from one content playback device to another. The on-screen preview is beneficial because certain settings, such as brightness, are on occasion hard to gauge without reviewing a content item itself, because the content item may be dark and a higher than normal contrast may be required.

Other advantages will be apparent from the description that follows, including the figures and claims.

### BRIEF DESCRIPTION OF THE DRAWINGS

Like reference numerals denote like elements throughout.

FIG. 1 is a block diagram of an exemplary system in accordance with one aspect of the present principles.

FIG. 2 is a sequence diagram illustrating a system and method according to one aspect of the present principles.

FIG. 3 is a flowchart illustrating an exemplary method according to one aspect of the present principles.

FIG. 4 is a block diagram of an exemplary second display system in accordance with one aspect of the present principles.

FIG. 5 is a block diagram of another exemplary second display system in accordance with one aspect of the present principles.

FIG. 6 illustrates an exemplary computing environment, e.g., that of the disclosed second display, proxy server, management server, or content server.

### DETAILED DESCRIPTION

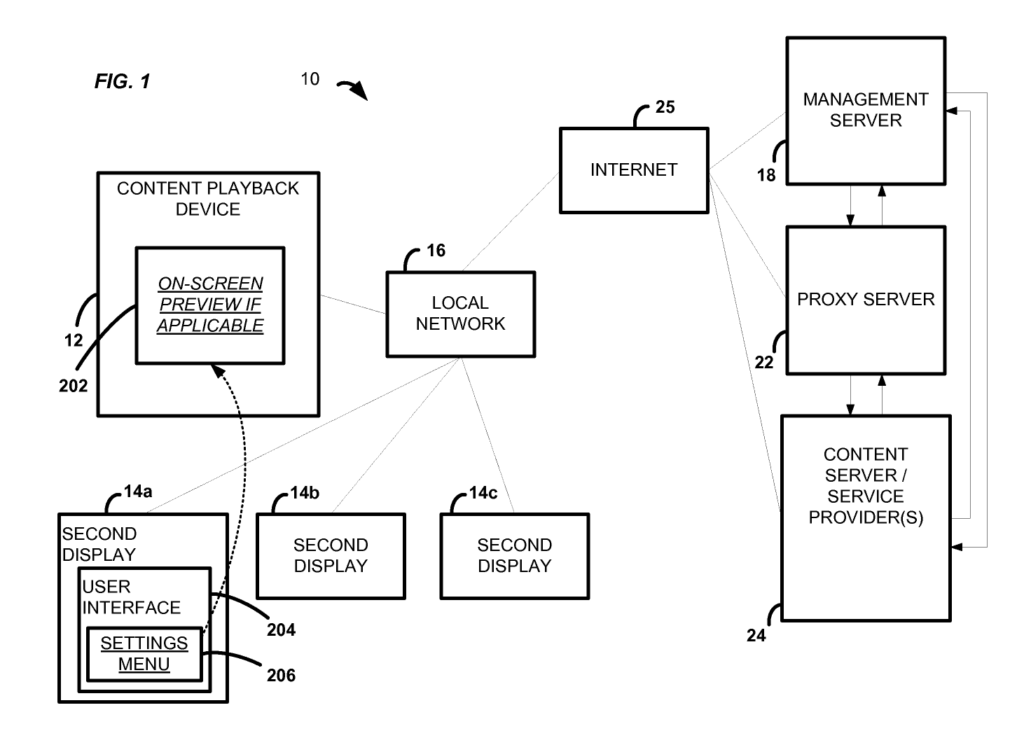

Referring initially to FIG. 1, a system 10 is shown including a content playback device 12 coupled to a local network 16, which may be wired, wireless, or a combination of both. Also coupled to the local network 16 are one or more second displays 14a-14c, an exemplary one of which is termed herein second display 14i. A number of servers may be accessed by the content playback device 12 and the second display 14i through the local network 16 and the internet 25, including a management server 18, a proxy server 22, and one or more content servers 24 corresponding to service providers.

The second display 14a further includes a user interface 204 through which a user may access a settings menu 206, so as to affect the display of a content item playing on the content playback device 12. As will be described below, certain modifications made in the settings menu 206 may result in an on-screen preview 202 of the intended modifications at the content playback device 12. For example, if a user changes the brightness of the content playback device 12 display at the settings menu 206, the same may appear in an on-screen preview 202.

The content playback device 12 may be, e.g., an IPTV, a digital TV, a digital sound system, a digital entertainment system, a digital video recorder, a video disc player, a combination of these, or any number of other electronic devices addressable by a user on the local network 16. For the sake of simplicity, in this specification, the content playback device 12 will occasionally be exemplified by an IPTV, in which case it will generally include a processor that controls a visual display and an audio renderer such as a sound processor and one or more speakers. The processor may access one or more computer-readable storage media such as but not limited to RAM-based storage, e.g., a chip implementing dynamic random access memory (DRAM), flash memory, or disk-based storage. Software code implementing present logic executable by the content playback device 12 may also be stored on one of the memories shown to undertake present principles. The processor can receive user input signals from various input devices including a remote control device, a point-and-click device such as a mouse, a keypad, etc. A TV tuner may be provided in some implementations, particularly when the content playback device 12 is embodied by an IPTV, to receive TV signals from a source such as a set-top box, satellite receiver, cable head end, terrestrial TV signal antenna, etc. Signals from the tuner are then sent to the processor for presentation on the display and sound system. A network interface such as a wired or wireless modem communicates with the processor to provide connectivity to the Internet through the local network 16. It will be understood that communications between the content playback device 12 and the internet 25, or between the second display 14i and the internet, may also take place through means besides the local network 16. For example, the second display 14i may communicate with the content playback device 12 through a separate mobile network.

The one or more second displays 14a-14c each bear a processor and components necessary to operate an application, e.g., one that allows control of settings of an IPTV. In particular, the processor in the second display may access one or more computer-readable storage media such as but not limited to RAM-based storage, e.g., a chip implementing dynamic random access memory (DRAM), flash memory, or disk-based storage. Software code implementing present logic executable by the second display may also be stored on one of the memories described below to undertake present principles. Further, the second display 14i can receive user input signals from various input devices including a point-and-click device such as a mouse, a keypad, a touchscreen, a remote control, etc. A network interface such as a wired or wireless modem communicates with the processor to provide connectivity to wide area networks such as the Internet as noted above.

The servers 18, 22, and 24 have respective processors accessing respective non-transitory computer-readable storage media which may be, without limitation, disk-based and/or solid state storage. The servers communicate with a wide area network such as the Internet via respective network interfaces. The proxy server 22 may in some cases be combined with the management server 18, although in many cases it may be preferable to separate the servers to better accommodate server load. The servers may mutually communicate via the internet 25. In some implementations, the servers may be located on the same local network, in which case they may communicate with each other through the local network without accessing the internet. For example, in one exemplary implementation, the management server 18 and the proxy server 22 may be disposed in the same data center, so communication between the two may stay within the data center.

While an exemplary method of the system is described below, certain method steps especially pertinent to certain arrangements of the second display will be described here.

Responsive to the second display 14i sending a request to the proxy server 22 for an executable utility, the proxy server 22 returns the utility to each second display 14i. Running the utility causes the instantiation of an application. The implementation discussed here includes a web application, but it will be understood that other types of applications may also be employed as described above. The second display 14i, executing the web application, prompts a user to input to each second display 14i login information. The login information may be common or may differ between second displays. The proxy server 22, responsive to reception of correct login information from the content playback device 12, returns the local IP address of the content playback device 12 to the second display 14i, because the same has previously been registered to a user account in which such information is maintained. The proxy server 22 may also return a list of content playback devices on the local network, responsive to which the second display 14i may select one for content playback. In turn, each second display 14i uses the local content playback device address to access the content playback device 12 directly to request information about the content playback device 12, which information is returned from the content playback device 12 to the second display 14i such that the local address of the content playback device 12 need not be globally addressable. Each second display 14i may also select content for playback on different content playback devices. The second display 14i sends the information about the content playback device 12 to the proxy server 22, requesting a list of services available to the content playback device 12 from one or more service providers. The services may be dependent on the device characteristics of the content playback device 12 chosen. For example, if the chosen content playback device 12 is an IPTV, video services may be returned. If the chosen content playback device 12 is an audio system, audio services may be returned.

The proxy server 22 relays the request for a list of services to the management server 18, which returns the list to the proxy server 22, with the proxy server 22 in turn sending the list to the second display 14i for presentation of information on the second display 14i. Responsive to a user selection of an item on the list, the second display 14i sends a request for a software asset corresponding to the selected content item to the proxy server 22. The proxy server 22 requests a service login of the content server 24 providing the content, and the content server 24 provides to the proxy server 22 a list of content items, assets, categories, or services, and the proxy server 22 relays the list to the second display 14i, which is presented on the second display 14i so that the user can navigate to enter a selection. Responsive to the selection, the second display 14i sends a command to the content playback device 12 to access and play back the selection.

The command to play the local content item may be in a number of forms. The second display 14i may communicate to the proxy server 22 the request on behalf of the content playback device 12, and this request may be via the local network or via other means. Alternatively, the second display 14i may transmit a request to the content playback device 12 that it itself formulate the request, and this transmission may be by way of the local network, the internet generally, or via other means such as other wired or wireless transmission schemes, including via USB, IR, Bluetooth®, or any other schemes. If the second display 14i is configured to address the content playback device 12 at a non-local level, e.g., at the server level, then the second display 14i may be physically located virtually anywhere and still be able to queue content or to command the content playback device 12 to play content. In this case, however, server load would increase over the case where the second display and content playback device communicated directly or over a local network.

Certain method steps of an arrangement of the content playback device are described here. Using a network interface, the content playback device 12 can communicate with a management server 18 on the Internet and with one or more content servers 24, also on the internet and communicating with the management server 18. The management server 18 receives and stores a local IP address of the content playback device 12. The content playback device 12 communicates with the management server 18 to arrange for content items from the content server 24, operated by a service provider, to be played back on the content playback device 12. In more detail, the content playback device 12 sends login information to the management server 18 which returns to the content playback device 12 a user token that must subsequently be presented by the content playback device 12 to the content server 24 to obtain content from the content server 24.

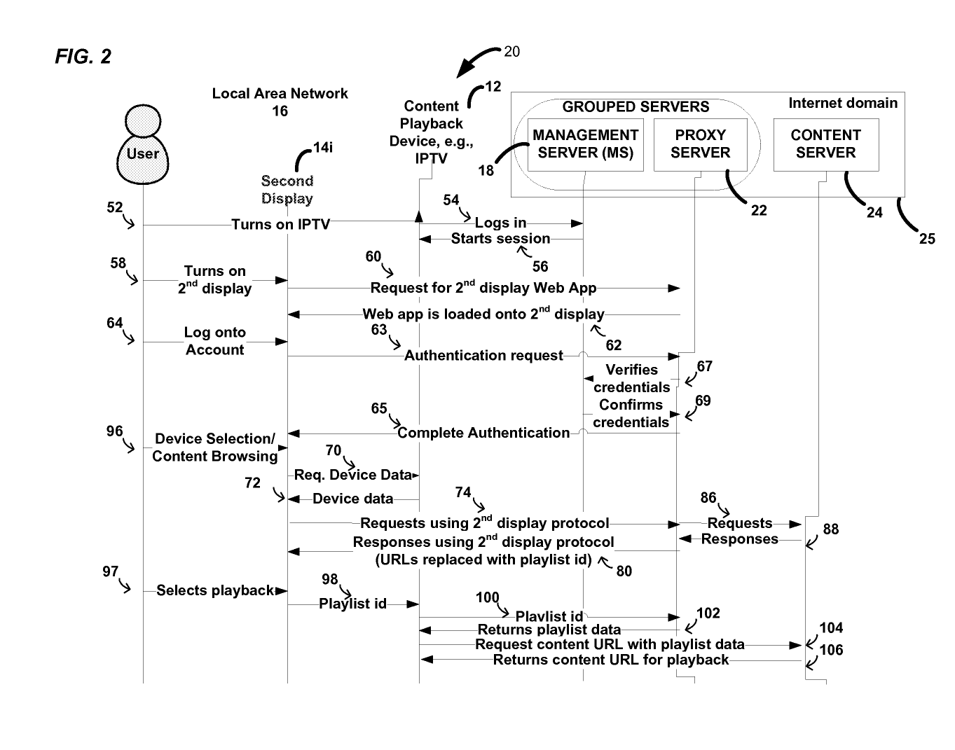

FIG. 2 is a sequence diagram illustrating an exemplary implementation of the system and method for enabling a user to employ a second display to browse content playback devices, service providers, content items and select the same for playback by a content playback device. FIG. 2 assumes that the user has already created an account with a management server and has affiliated one or more content playback devices with that account.

At state 52, a user turns on the content playback device 12. At state 54 the content playback device sends login information including, e.g., username and password, to the management server 18, which at state 56 returns to the content playback device a user token that may subsequently be presented by the content playback device to a content server 24 to obtain content from that server. The management server 18 in addition stores the local IP address of the content playback device 12.

At state 58, the user turns on the second display 14i and, e.g., instantiates a web browser session in which control may be exercised over the content playback device. A utility is executed on the second display 14i, at state 60, which sends a request to the proxy server 22, which returns in state 62 a web application, e.g., HTML with JavaScript, for the second display to execute for browsing content items. This application may make, e.g., asynchronous JavaScript and XML calls to the proxy server 22 and to the content playback device 12 to obtain information to control the content playback device 12.

With more specificity, at state 64, using the JavaScript received from the proxy server 22, the second display 14i prompts the user to input to the second display 14i the account login information, including, e.g., the same username and password that the content playback device provided to the management server 18 in state 54 during device registration. Of course, the account login information may differ as well. It will be appreciated that the servers 18, 22, and 24 communicate necessary account information between them as needed to realize the principles described here.

The proxy server 22 responds to a correct user name and password from the second display 14i in an authentication request state 63. The proxy server 22 verifies the user name and password with the management server 18 (states 67 and 69), creates and transmits a session token to the second display, obtains information about content playback devices affiliated with the user account, and completes the authentication in state 65. The proxy server 22 may return to each second display the information about all content playback devices 12 that are affiliated with the user account associated with the user name and password, including their local IP addresses which were stored by the management server 18 after login at 54 (and subsequently provided to the proxy server 22). In more detail, the proxy server 22 sends a token to the second display 14i, the token associated with a content playback device, and this token gets communicated in future transactions between the second display and the proxy server, so that the proxy server 22 knows what content playback device the content item is intended for. Each user with each second display may then choose a content playback device and browse the services and content options available through the services in state 96 and subsequent steps.

The second display 14i, using the local IP address returned as noted above, accesses the content playback device directly, in the sense of communicating through the local network. To select a particular content playback device, the second display 14i requests information about the content playback device 12 at state 70, including language information, digital rights management (DRM) information, etc., as desired, which information is returned from the content playback device to the second display 14i at state 72. Since the second display 14i knows the IP address of the content playback device 12 and consequently communicates directly with the content playback device 12, the second display 14i communicates using a local web address of the content playback device 12 that need not be globally addressable, and may so communicate as long as the second display 14i and content playback device 12 are on the same local network.

Each second display 14i may send the client information received at state 72 to the proxy server 22, requesting a list of services available to the content playback device 12, or that the content playback device 12 is entitled to, from one or more of the content servers 24. The proxy server 22 relays the request to the management server 18, which returns the requested service list to the proxy server 22. The proxy server 22 in turn sends the services list to the second display for presentation of available services on, e.g., a display of the second display. Each user browses the services and their content on the second display just as though it were the actual content playback device.

A user can input, using, e.g., a second display input device, a selection of a service on the list that was returned to the second display. In response, the second display, at state 74, sends a request for the corresponding service to the proxy server 22 along with the service token that that second display may have received from the content server 24 via the management server 18.

Responsive to the request, the proxy server 22 requests a service login at state 86 of the content server 24 providing the selected service. At state 88, the content server 24 provides to the proxy server 22 a list of content items, assets, categories or services, as the case may be, for the particular content server 24. If desired, the proxy server 22 may also request of the content server 24 a list of options, and the list may be returned in, e.g., extended markup language (XML) format to the proxy server 22 which relays the content items, assets, categories, services, etc. available for selection to the second display at the state 80.

The content available for selection is presented on the second display so that the user can navigate in state 97 the display to enter a selection. Responsive to the selection, the second display at state 98 sends a command to the content playback device 12 to play the selection, and in particular sends a playlist id or reference identifier indicating the selection. At state 100, the content playback device 12, using its authentication credentials, sends the playlist id or reference identifier to the proxy server 22, which returns the required playlist data in state 102. The content playback device 12 can then request the content URL with the playlist data in state 104, which may be responded to with a return of the content URL for playback of the content item on the content playback device 12 in state 106.

Variations of the system and method are now described.

If the content playback device were already playing content, the new content commanded to be played by the second display may be placed in a queue in the content playback device and played when the current content completes. In any case, once the content has been commanded to be played, the user may continue to browse the second display for other content, to play or to add to the queue. Other users may employ their own second displays to do the same. A user may also desire to switch devices and resume playback on a different device by, e.g., navigating to a “recently viewed” list and selecting the last video played after switching control to the desired device.

The above description has been for the case where the proxy server 22 is employed to hide the content source, e.g., a content URL, from the second display 14i. That is, the proxy server 22 provides an API for the second display to use so that the content and/or content URL cannot be accessed directly, i.e., the details of the management server transactions to access the services remain desiredly unknown. In many cases, the second display 14i may have stored thereon little or nothing of the content playback device 12 details. In some cases, however, the URL may be directly provided from the proxy server 22 or the proxy server 22 may even be bypassed, e.g., in cases where the content item is intended for free distribution, e.g., movie trailers or the like. Similarly, while the above description has focused on content item playback on content playback device 12, certain content items, e.g., those which are intended for free distribution, may be played back on the second display 14i itself. Moreover, control of settings of IPTVs generally need not entail the proxy server, and in many cases need not entail communications beyond the local network.

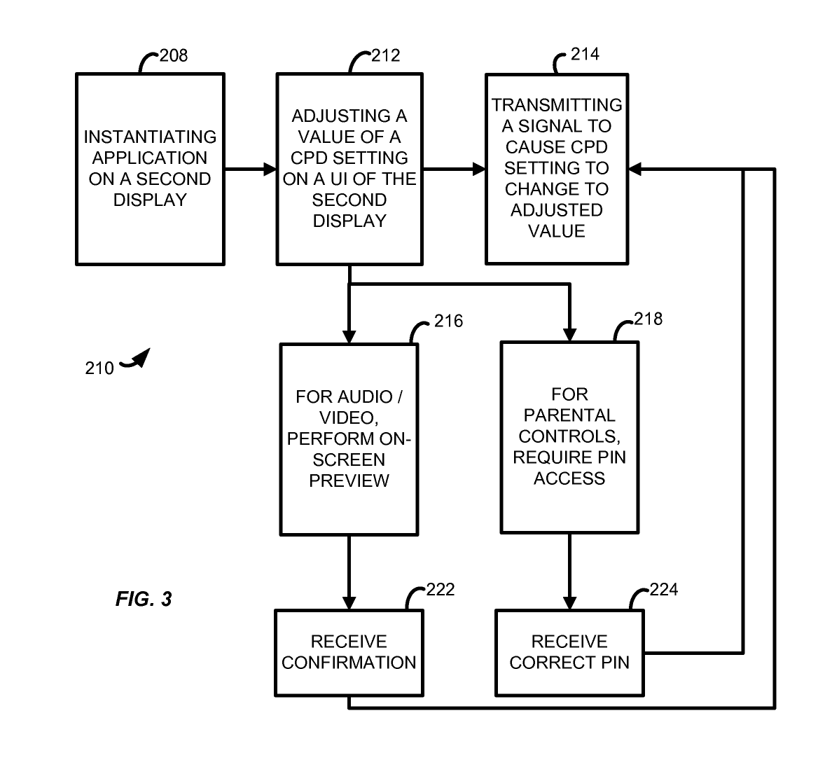

Referring to FIG. 3, a flowchart 210 is shown illustrating an exemplary method. A first step of the method is the instantiation of an application on a second display (step 208). This application may be resident on the second display, or may be downloaded just prior to use. The application may be a web application; other types of such applications have been noted above, including those written in native code, Java, or the like. A next step is the adjusting of the value of a content playback device setting on a user interface of the second display, such as on a settings menu (step 212) on a user interface of the second display. A final step is transmitting a signal from the second display to cause the content playback device setting to change to the adjusted value (step 214). Where the setting has been adjusted for a preview, this step may simply be a signal indicating that the adjustment is to be regarded and stored as the new setting until changed again.

For some types of settings, additional steps may be taken. For example, following the adjusting step 212, and for audio and/or video settings, an on-screen preview maybe performed (step 216). That is, for settings susceptible to an on-screen preview, the same may be initiated on the content playback device so that the user can see the effect of the intended adjusting of the value. This may be particularly useful for settings such as brightness, which are on occasion difficult to gauge without looking at a piece of content itself, because the content may be dark and a higher than normal contrast may be required. In some cases, the preview may even occur on the second display. Such a capability may be particularly directed to content items which are safe to display on the second display, e.g., those which are publicly distributable and/or those that are DRM-free. Such previews may especially pertain to, e.g., captioning, ratings, or the like. In any case, the preview may be accompanied with a request for confirmation from a user (step 222). Responsive to an indication from the user that the previewed value of the setting is satisfactory, step 214 may be performed of transmitting a signal to cause the content playback device setting to change to the adjusted value. Of course, the confirmation may be passive or active—the user may confirm by not responding or otherwise further adjusting the value as well as by affirmatively clicking a confirmation button.

In another variation, for adjusting or modifying parental controls, a request for a personal identification number or PIN may be requested prior to access (step 218). Responsive to receipt of a correct PIN from the user (step 224), a signal may be transmitted allowing the content playback device to change to the adjusted value of the parental control. In some cases, steps 212 and 218 may be initiated when a user accesses a content item requiring a parental access code. In this case, the transmitted signal would lead to access and playback of the content item and/or modification of the parental control level of the content playback device, at least for that content item.

It is further noted in regard to FIG. 3 that many other settings may be adjusted or changed or modified besides those shown. In some cases, confirmation may be requested from the user. In other cases, a user may be requested to input a code. In other cases, the change may be immediately made to the content playback device.

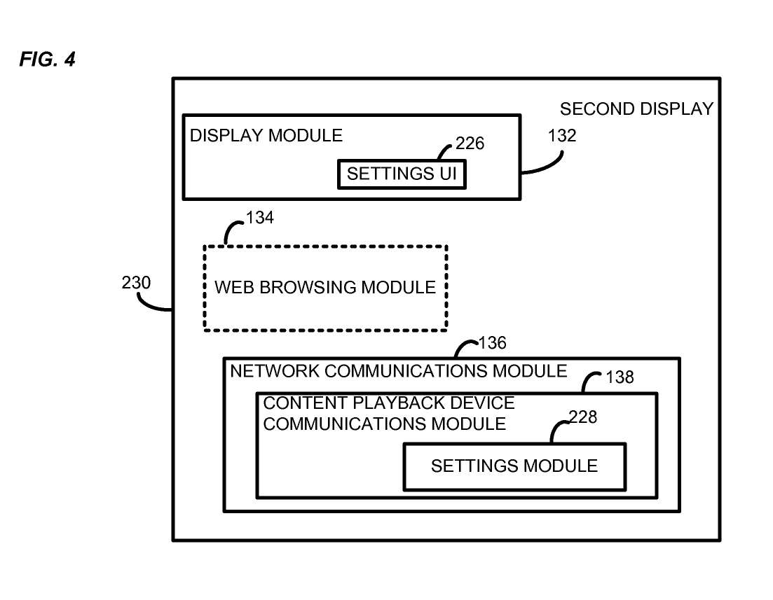

Referring to FIG. 4, an exemplary implementation of a second display 230 is illustrated. The second display 230 includes a display module 132 for use in, among other aspects, browsing lists and selecting items related to the content playback device. The second display 230 includes a settings user interface module 226 as part of the display module 132. The settings user interface module 226 may display, e.g., a high level grouping or categorization of settings, a number of settings within each grouping or category, the current value of one or more settings, as well as a way to adjust the value of those settings.

The second display 230 also includes a module for network communications 136. The network communications module 136 allows the second display to communicate with the local network as well as, in some cases, specific devices directly. As part of the network communications module 136, a communications module 138 for communications with a content playback device is provided. The content playback device communications module 138 allows the second display to communicate with the content playback device either over the local network or directly (internet communications may also be employed). Such direct communications may include various types of wired or wireless transmission schemes, including WiFi, USB, infrared, Bluetooth®, or the like.

The content playback device communications module 138 further includes a settings module 228. The settings module 228 may communicate current values of settings to the second display 230 and may also communicate adjustments of those settings to the content playback device upon command of a user. In so doing, the settings module 228 many communicate adjustments in values of settings directly to the content playback device via any number of wireless or wired techniques, including WiFi, Bluetooth®, infrared, or the like. The settings module 228 may also communicate adjustments through the local network 15 or alternatively over the Internet 25. In many cases, however, it will be noted that a direct link such as by Bluetooth® is convenient and eliminates or reduces undesired excess server load.

Also within the second display 230 may be an optional web-browsing module 134 through which the above noted content items may be browsed in the case where the second display application is written in HTML and Javascript. The web-browsing module 134 may be implemented in a number of ways, including in HTML, Javascript, or the like. A web browsing module implemented in such a way allows the same to be implemented across many platforms, allowing any number of types of second displays to be employed. In some cases, however, special applications, e.g., helper applications, may be employed to communicate with particular proprietary or non-web-based technologies. Where the second display application is non-web-based, and is written in, e.g., native code, the web-browsing module 134 may be replaced with a suitable other module allowing service and content selection or other such functionality.

It is noted that the above modules may be implemented in hardware, non-transitory software, or a combination of the above. Typically, the same will be implemented within the context of a laptop computer, a tablet computer, a smart phone, or the like.

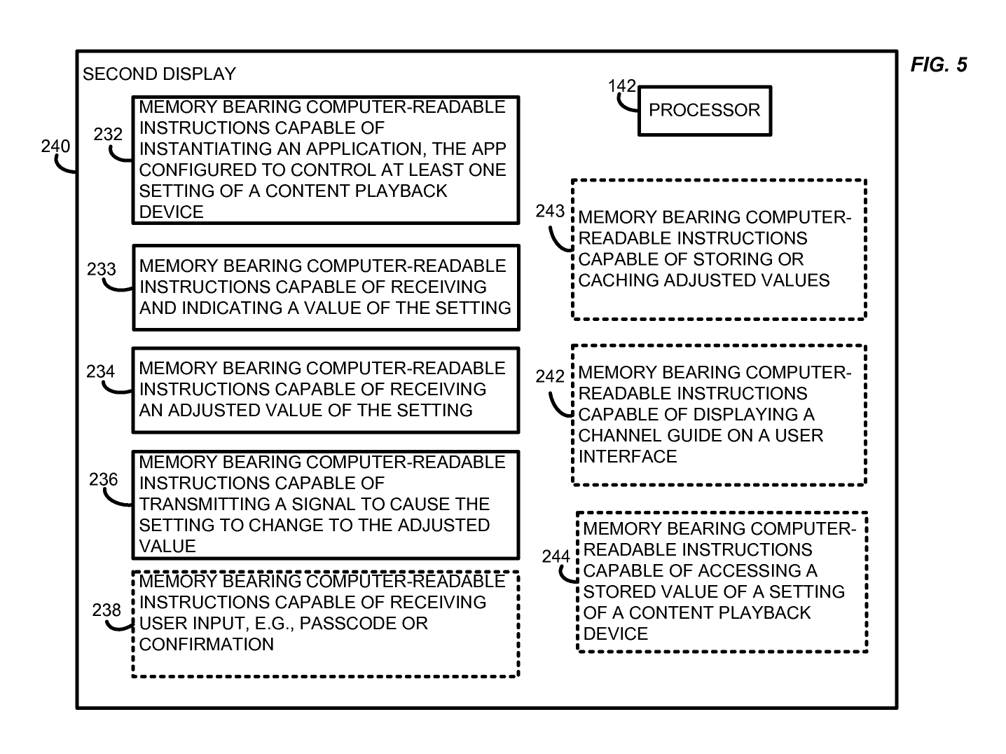

FIG. 5 illustrates another implementation of a second display 240. The second display 240 includes a processor 142 as noted above. The second display 240 further includes memory 232 bearing computer readable instructions capable of instantiating an application, the application configured to control at least one setting of a content playback device. The second display 240 further includes memory 233 bearing computer readable instructions capable of receiving and indicating a value of the setting. The second display 240 further includes memory 234 bearing computer readable instructions capable of receiving an adjustment of a value of the setting. As noted above, such an adjustment may generally be indicated on a user interface of the second display. The second display 240 further includes memory 236 bearing computer readable instructions capable of transmitting a signal to cause the setting to change to the adjusted value. The second display 240 further includes memory 238 bearing computer readable instructions capable of receiving a user input, e.g., a passcode or confirmation. The memory 238 may be particularly pertinent where a user is entering a passcode or confirming that the appearance of a previewed setting corresponds to that which is desired. The second display 240 further includes memory 242 bearing computer readable instructions capable of displaying a channel guide on a user interface. The channel guide may correspond to a listing of channels, with current and upcoming content offerings for each channel displayed in a grid or matrix. The memory 242 generally requires access to one of the servers mentioned above, or others, in order to obtain information to display about content offerings and channel listings display. The second display 240 may include memory 244 bearing computer readable instructions capable of accessing a stored value of the setting of a content playback device. This stored value may be that of a prior content playback device, a default value, or any other value that may be employed as a starting or initial value. Such stored values may be useful in quickly populating settings values for a content playback device that is new to the user or in a new location. The stored values may be provided from information stored in the user account, or alternatively from a location on the local network or elsewhere. Stored values may also be obtained by having the second display query the actual values of the current settings of the content playback device. Finally, though not exclusively, the second display 240 may include memory 243 bearing computer readable instructions capable of storing or caching values of adjusted settings. The same may be especially pertinent when a connection is disrupted between the second display and a content playback device; in this case, the cached settings may be communicated once the connection is reestablished.

Systems and methods have been disclosed that allow improvement of the user experience of the IPTV without adding to the hardware costs of the unit. As disclosed above, software may be created and employed to allow a user to control the IPTV settings from a second display, e.g., on a second display. In one implementation, such settings include brightness, volume, parental controls, input controls, language, clock, zip code etc. Instant on-screen preview, wherever applicable, may be available when changing settings using the second display.

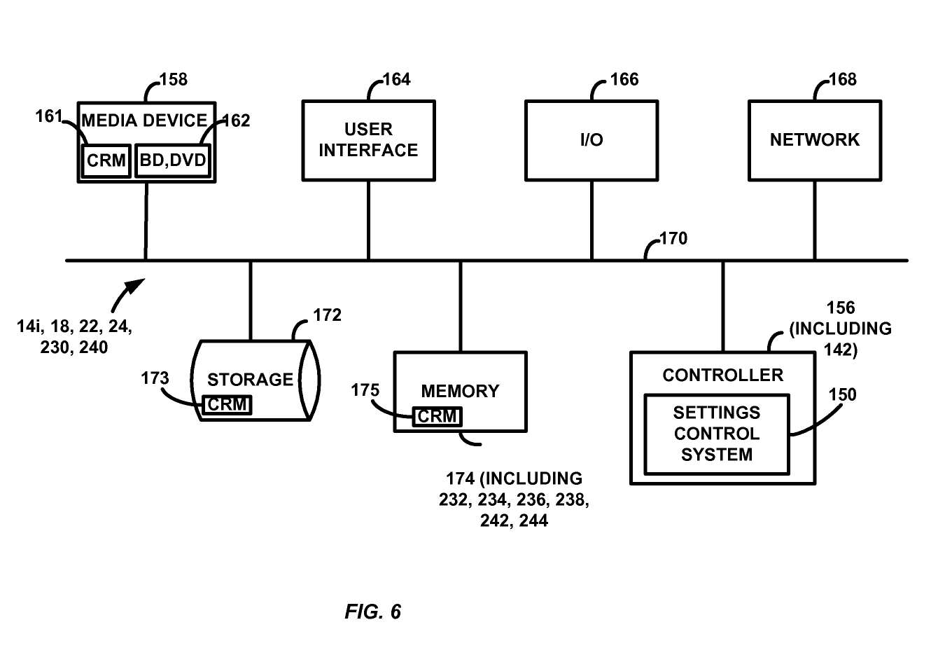

One implementation includes one or more programmable processors and corresponding computing system components to store and execute computer instructions, such as to execute the code that provides the second display or various server functionality, as well as for browsing. The second display 14i functionality will be focused on here, but it will be understood that the various server functionality, e.g., that of the proxy server 22, management server 18, and content server 24, may also be accomplished with such components. Referring to FIG. 6, a representation of an exemplary computing environment for a second display is illustrated.

The second display 14i includes a controller 156, a memory 174, storage 172, a media device 158, a user interface 164, an input/output (I/O) interface 166, and a network interface 168. The components are interconnected by a common bus 170. Alternatively, different connection configurations can be used, such as a star pattern with the controller at the center.

The controller 156 includes a programmable processor and controls the operation of the second display 14i and its components for a settings control system 150. The controller 156 loads instructions from the memory 174 or an embedded controller memory (not shown) and executes these instructions to control the system. In its execution, the controller 156 may provide the second display 14i control of a content playback device system 12 as, in part, a software system. Alternatively, this service can be implemented as separate modular components in the controller 156 or the second display 14i.

Memory 174, which may include non-transitory computer-readable memory 175, stores data temporarily for use by the other components of the second display 14i, and the same may include memories 232-234, 236, 238, and 242-244 as discussed above. In one implementation, memory 174 is implemented as RAM. In other implementations, memory 174 also includes long-term or permanent memory, such as flash memory and/or ROM.

Storage 172, which may include non-transitory computer-readable memory 173, stores data temporarily or long-term for use by other components of the second display 14i, such as for storing data used by the system. In one implementation, storage 172 is a hard disc drive or a solid state drive.

The media device 158, which may include non-transitory computer-readable memory 159, receives removable media and reads and/or writes data to the inserted media. In one implementation, the media device 158 is an optical disc drive or disc burner, e.g., a writable Blu-ray® disc drive 162.

The user interface 164 includes components for accepting user input, e.g., the user content selections, from the user of the second display 14i and presenting information to the user. In one implementation, the user interface 164 includes a keyboard, a mouse, audio speakers, and a display. The controller 156 uses input from the user to adjust the operation of the second display 14i.

The I/O interface 166 includes one or more I/O ports to connect to corresponding I/O devices, such as external storage or supplemental devices, e.g., a printer or a PDA. In one implementation, the ports of the I/O interface 166 include ports such as: USB ports, PCMCIA ports, serial ports, and/or parallel ports. In another implementation, the I/O interface 166 includes a wireless interface for wireless communication with external devices. These I/O interfaces may be employed to connect to one or more content playback devices.

The network interface 168 allows connections with the local network and optionally with content playback device 12 and includes a wired and/or wireless network connection, such as an RJ-45 or Ethernet connection or “WiFi” interface (802.11). Numerous other types of network connections will be understood to be possible, including WiMax, 3G or 4G, 802.15 protocols, 802.16 protocols, satellite, Bluetooth®, or the like.

The second display 14i may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

Various illustrative implementations of the present invention have been described. However, one of ordinary skill in the art will recognize that additional implementations are also possible and within the scope of the present invention. For example, in one implementation, the content playback device may be caused to display content that is helpful in determining when the settings being adjusted are set to optimum levels. For example, a grid pattern could be displayed when the user is adjusting the keystoning; a picture of a group of people with a variety of skin tones could be displayed when the user is adjusting the hue; and a picture with significant shadow detail and highlight detail may be displayed when the user is adjusting the brightness. These helpful illustrations may be caused to be displayed by the second display, or could be initiated by the content playback device itself; however, the content playback device may generally still show the settings adjustment user interface on top of the content.

Other variations will also be seen. For example, the application running on the second display may be a web application, a native application, a Java application, or any other sort of application that may work with a content playback device. Moreover, while several implementations of the invention include that the user select a particular content playback device for playback, in some implementations a user may browse content with no content playback device selected at all. The user may also browse transactions like video rentals or home shopping purchases on the second display. The user may also request content items to be played back that are resident within the local network, e.g., content stored on a DVR or Blu-ray® player or accessible through DLNA technology. In this regard, the control of the settings may extend to control of, e.g., the DVR, allowing access to the programs stored thereon, and allowing deletion and content queueing of the programs, as well as other operations. While the system and method have described implementations in which content playback devices have been selected before browsing and where little or no reference to content playback devices is made, other variations are possible. For example, a cache or cookie or other information may be employed to store information about content playback devices, so that no user choice is necessary. In another example, samples of content items may be obtained from content service providers, and these samples may be browsed freely without a user selection of a content playback device for playback. In another variation, a profile system may be employed that communicates content playback device information upon start-up according to a profile; e.g., a given content playback device may always be associated with and may authenticate itself with a given service provider. In this sense, a content playback device is still being chosen, but the choice does not require an affirmative step by the user. Use of any of these alternatives, or others, ensures that the content consumption of each content playback device is tracked. It further allows, as described, the proxy server to filter out content that the content playback device is incapable of playing. It is also noted that certain types of browsing may require no device at all, e.g., browsing shopping sites. Still, some level of customization may occur, e.g., by consideration of the origination location of the visiting second display's IP address.

In addition, the above description was primarily directed to an implementation in which the local IP address of the second display was retrieved and stored on the server. However, other ways of discovering the second display are also possible. For example, device discovery is also possible using a broadcast method within the local network. Compatible devices that recognize the broadcast message will respond with their necessary credentials and information to indicate their compliance with the web application for the second display. In many cases, broadcasting methods are primarily directed to native applications, not web applications; however, a broadcasting library may be employed to allow the implementation within a web application.

The control of settings of any suitable devices is contemplated, including but not limited to those connected over the following schemes: networked, wireless, including 3G, 4G, and the like, local, e.g., those including a local or shared drive or accessible via DLNA or accessible via a specialized network storage device, or devices controlling removable media such as a media card or USB storage device, CD, DVD, or Blu-ray. Other suitable devices which may be accessed include a cell phone, a portable media player, a camera or camcorder, or other devices. Any suitable protocol is contemplated, including but not limited to HTTP, HTTPS, etc. While the above description has focused on implementations where a second display is coupled to a content playback device through a local network, it will be understood that the same will apply to any method by which the two may communicate, including 3G, 4G, and other such schemes. Moreover, settings control need not occur in real-time—the same may be cached or stored, especially when a connection with a content playback device has been disrupted. The same may then be pushed when the connection is re-established.

Accordingly, the present invention is not limited to only those implementations described above.

1. A method of controlling settings of a content playback device using a second display, comprising:
i. instantiating an application on a second display, the second display coupled to a content playback device, the application configured to control at least one setting of the content playback device;
ii. on a user interface of the second display, the user interface indicating a setting of the content playback device, adjusting a value of a content playback device setting; and
iii. transmitting a signal to cause the content playback device setting to change to the adjusted value.

2. The method of claim 1, wherein the setting corresponds to an audio or video setting, further comprising:
i. upon the adjusting, transmitting a signal to cause the content playback device setting to change to the adjusted value to preview an effect of the adjusting;
ii. requesting confirmation from a user for the adjusted value of the setting; and
iii. responsive to receiving confirmation from a user for the adjusted value of the setting, performing the step of transmitting a signal to cause the content playback device setting to change to the adjusted value.

3. The method of claim 1, wherein the setting corresponds to a parental control, further comprising:
i. upon the adjusting, requesting a passcode from a user; and
1. responsive to a correct passcode being entered by a user, allowing a modification of the parental control setting; or
2. allowing access or playback of a content item protected by the parental control.

4. The method of claim 3, wherein a user has requested a content item from a service provider, and wherein the passcode request originates from the service provider.

5. The method of claim 1, wherein the setting corresponds to a channel, further comprising:
i. displaying a channel guide;
ii. responsive to an adjusted channel value being indicated by a user, performing the step of transmitting a signal to cause the content playback device channel setting to change to the adjusted value.

6. The method of claim 1, wherein the transmitting a signal includes transmitting a signal directly from the second display to the content playback device via a wireless transmission scheme selected from the group consisting of: Bluetooth®, WiFi, or infrared.

7. The method of claim 1, wherein the content playback device is an IPTV or a digital video recorder.

8. The method of claim 1, wherein the adjusting a value of a content playback device setting includes adjusting the value to equal a stored value, the stored value associated with another content playback device.

9. A non-transitory computer-readable medium, comprising instructions for causing a computing device to implement the method of claim 1.

10. A second display, comprising:
i. a display module, including a settings user interface module, wherein the settings user interface module is configured to display a grouping or categorization of settings, a number of settings within each grouping or category, the current value of one or more settings, and a way to receive an adjustment of the value of those settings; and
ii. a network communications module including a content playback device communications module for communications with a content playback device.

11. The second display of claim 10, wherein the second display is configured to communicate directly with a content playback device through the network communications module.

12. The second display of claim 11, wherein the direct communication is via a wireless link.

13. The second display of claim 11, further comprising a web-browsing module for browsing the web.

14. A second display, comprising:
i. a processor;
ii. memory bearing computer readable instructions capable of instantiating an application, the application configured to control at least one setting of a content playback device;
iii. memory bearing computer readable instructions capable of receiving and indicating a value of the setting;
iv. memory bearing computer readable instructions capable of receiving an adjustment of a value of the setting;
v. memory bearing computer readable instructions capable of transmitting a signal to cause the setting to change to the adjusted value.

15. The second display of claim 14, further comprising memory bearing computer readable instructions capable of receiving a user input of a passcode or confirmation.

16. The second display of claim 14, further comprising memory bearing computer readable instructions capable of displaying a channel guide on a user interface.

17. The second display of claim 14, further comprising memory bearing computer readable instructions capable of accessing a stored value of the setting of a content playback device.

18. The second display of claim 17, wherein the stored value is retrieved from another content playback device, a default value, or a current value of the content playback device.

19. The second display of claim 17, wherein the stored value is retrieved from information stored in the user account or a location on the local network.

20. The second display of claim 14, further comprising memory bearing computer readable instructions capable of storing or caching settings adjustments.
